(19) United States
(12) Patent Application Publication
(10) Pub. No.: US 2017/0236641 A1
(43) Pub. Date: Aug. 17, 2017

(54) FURUTA CO-POLYMER AND CAPACITOR

(71) Applicant: Capacitor Sciences Incorporated, Menlo Park, CA (US)

(72) Inventors: Paul Furuta, Sunnyvale, CA (US); Barry K. Sharp, Redwood City, CA (US); Pavel Ivan Lazarev, Menlo Park, CA (US)

(21) Appl. No.: 15/043,186

(22) Filed: Feb. 12, 2016

(51) Int. Cl. H01G 4/18; H01B 3/44; C08F 220/68

(52) U.S. Cl. CPC H01G 4/18; C08F 220/68; H01B 3/447

(57) ABSTRACT

An organic co-polymeric compound characterized by polarizability and resistivity has a general structural formula:

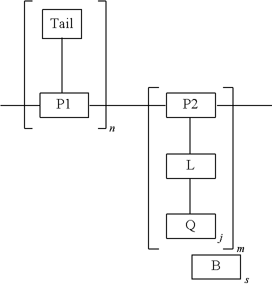

P1 and P2 are structural units selected from acrylate, methacrylate, repeat units for polypropylene (PP), repeat units for polyethylene (PE), siloxane, and repeat units for polyethylene terephthalate. Tail is a resistive substitute that includes an oligomer of a polymeric material and n is a number of P1-Tail repeat units. Q is an ionic functional group, which is connected to the structural unit P2 via a linker group L, and m is a number of P2-L-Q repeat units. The ionic functional group Q comprises one or more ionic liquid ions, zwitterions, or polymeric acids. B is a counter ion in the form of a molecule or oligomer that can supply an opposite charge to balance a charge of the co-polymer, and s is the number of the counter ions in the compound.

### FIELD OF THE INVENTION

The present disclosure relates generally to passive components of electrical circuit and more particularly to an organic co-polymeric compound and capacitor based on this material and intended for energy storage.

### BACKGROUND

A capacitor is a passive electronic component that is used to store energy in the form of an electrostatic field, and comprises a pair of electrodes separated by a dielectric layer. When a potential difference exists between the two electrodes, an electric field is present in the dielectric layer. An ideal capacitor is characterized by a single constant value of capacitance, which is a ratio of the electric charge on each electrode to the potential difference between them. For high voltage applications, much larger capacitors have to be used.

One important characteristic of a dielectric material is its breakdown field. This corresponds to the value of electric field strength at which the material suffers a catastrophic failure and conducts electricity between the electrodes. For most capacitor geometries, the electric field in the dielectric can be approximated by the voltage between the two electrodes divided by the spacing between the electrodes, which is usually the thickness of the dielectric layer. Since the thickness is usually constant, it is more common to refer to a breakdown voltage, rather than a breakdown field. There are a number of factors that can dramatically reduce the breakdown voltage. In particular, the geometry of the conductive electrodes is important factor affecting breakdown voltage for capacitor applications. In particular, sharp edges or points hugely increase the electric field strength locally and can lead to a local breakdown. Once a local breakdown starts at any point, the breakdown will quickly “trace” through the dielectric layer until it reaches the opposite electrode and causes a short circuit.

Breakdown of the dielectric layer usually occurs as follows. Intensity of an electric field becomes high enough to “pull” electrons from atoms of the dielectric material and makes them conduct an electric current from one electrode to another. Presence of impurities in the dielectric or imperfections of the crystal structure can result in an avalanche breakdown as observed in semiconductor devices.

Another of important characteristic of a dielectric material is its dielectric permittivity. Different types of dielectric materials are used for capacitors and include ceramics, polymer film, paper, and electrolytic capacitors of different kinds. The most widely used polymer film materials are polypropylene and polyester. Increasing dielectric permittivity allows for increasing volumetric energy density, which makes it an important technical task.

An ultra-high dielectric constant composite of polyaniline, PANI-DBSA/PAA, was synthesized using in situ polymerization of aniline in an aqueous dispersion of poly-acrylic acid (PAA) in the presence of dodecylbenzene sulfonate (DBSA) (see, Chao-Hsien Hoa et al., “High dielectric constant polyaniline/poly(acrylic acid) composites prepared by in situ polymerization”, Synthetic Metals 158 (2008), pp. 630-637). The water-soluble PAA served as a polymeric stabilizer, protecting the PANI particles from macroscopic aggregation. A very high dielectric constant of about 2.0×10⁵ (at 1 kHz) was obtained for the composite containing 30% PANI by weight. Influence of the PANI content on the morphological, dielectric and electrical properties of the composites was investigated. Frequency dependence of dielectric permittivity, dielectric loss, loss tangent and electric modulus were analyzed in the frequency range from 0.5 kHz to 10 MHz. SEM micrograph revealed that composites with high PANI content (i.e., 20 wt. %) consisted of numerous nano-scale PANI particles that were evenly distributed within the PAA matrix. High dielectric constants were attributed to the sum of the small capacitors of the PANI particles. The drawback of this material is a possible occurrence of percolation and formation of at least one continuous electrically conductive channel under electric field with probability of such an event increasing with an increase of the electric field. When at least one continuous electrically conductive channel (track) through the neighboring conducting PANI particles is formed between electrodes of the capacitor, it decreases a breakdown voltage of such capacitor.

Colloidal polyaniline particles stabilized with a water-soluble polymer, poly(N-vinylpyrrolidone) [poly(′-vinylpyrrolidin-2-one)], have been prepared by dispersion polymerization. The average particle size, 241±50 nm, have been determined by dynamic light scattering (see, Jaroslav Stejskal and Irina Sapurina, “Polyaniline: Thin Films and Colloidal Dispersions (IUPAC Technical Report)”, Pure and Applied Chemistry, Vol. 77, No. 5, pp. 815-826 (2005).

Single crystals of doped aniline oligomers are produced via a simple solution-based self-assembly method (see, Yue Wang, et. al., “Morphological and Dimensional Control via Hierarchical Assembly of Doped Oligoaniline Single Crystals”, J. Am. Chem. Soc. 2012, 134, pp. 9251-9262). Detailed mechanistic studies reveal that crystals of different morphologies and dimensions can be produced by a “bottom-up” hierarchical assembly where structures such as one-dimensional (1-D) nanofibers can be aggregated into higher order architectures. A large variety of crystalline nanostructures, including 1-D nanofibers and nanowires, 2-D nanoribbons and nanosheets, 3-D nanoplates, stacked sheets, nanoflowers, porous networks, hollow spheres, and twisted coils, can be obtained by controlling the nucleation of the crystals and the non-covalent interactions between the doped oligomers. These nanoscale crystals exhibit enhanced conductivity compared to their bulk counterparts as well as interesting structure-property relationships such as shape-dependent crystallinity. Furthermore, the morphology and dimension of these structures can be largely rationalized and predicted by monitoring molecule-solvent interactions via absorption studies. Using doped tetra-aniline as a model system, the results and strategies presented in this article provide insight into the general scheme of shape and size control for organic materials.

Thus, materials with high dielectric permittivity which are based on composite materials and containing polarized particles (such as PANI particles) may demonstrate a percolation phenomenon. The formed polycrystalline structure of layers has multiple tangling chemical bonds on borders between crystallites. When the used material with high dielectric permittivity possesses polycrystalline structure, a percolation may occur along the borders of crystal grains.

Hyper-electronic polarization of organic compounds is described in greater detail in Roger D. Hartman and Herbert A. Pohl, “Hyper-electronic Polarization in Macromolecular Solids”, Journal of Polymer Science: Part A-1 Vol. 6, pp. 1135-1152 (1968). Hyper-electronic polarization may be viewed as the electrical polarization external fields due to the pliant interaction with the charge pairs of excitons, in which the charges are molecularly separated and range over molecularly limited domains. In this article, four polyacene quinone radical polymers were investigated. These polymers at 100 Hz had dielectric constants of 1800-2400, decreasing to about 58-100 at 100,000 Hz. Essential drawback of the described method of production of material is use of a high pressure (up to 20 kbars) for forming the samples intended for measurement of dielectric constants.

Influence of acrylic acid grafting of isotactic polypropylene on the dielectric properties of the polymer is investigated using density functional theory calculations, both in the molecular modeling and three-dimensional (3D) bulk periodic system frameworks (see, Henna Russka et al., “A Density Functional Study on Dielectric Properties of Acrylic Acid Crafted Polypropylene”, The Journal of Chemical Physics, 134, 134904 (2011)). In molecular modeling calculation, polarizability volume, and polarizability volume per mass, which reflects the permittivity of the polymer, as well as the HOMO-LUMO gap, one of the important measures indicating the electrical breakdown voltage strength were various chain lengths and carboxyl mixture ratios.

The lowest unoccupied molecular orbital (LUMO) energies of a variety of molecular organic semiconductors have been evaluated using inverse photoelectron spectroscopy data and are compared with data determined from the optical energy gap, electrochemical reduction potentials, and density functional theory calculations (see, Peter I. Djuravich et al., “Measurement of the lowest unoccupied molecular orbital energies of molecular organic semiconductors”, Organic Electronics, 10, pp. 515-520, (2009)).

Capacitors as energy storage device have well-known advantages versus electrochemical energy storage, e.g. a battery. Compared to batteries, capacitors are able to store energy with very high power density, i.e. charge/recharge rates, have long shelf life with little degradation, and can be charged and discharged (cycled) hundreds of thousands or millions of times. However, capacitors often do not store energy in small volume or weight as in case of a battery, or at low energy storage cost, which makes capacitors impractical for some applications, for example electric vehicles. Accordingly, it may be an advance in energy storage technology to provide capacitors of higher volumetric and mass energy storage density and lower cost.

### SUMMARY

The present disclosure provides an organic co-polymeric compound characterized by high polarizability and high resistivity, referred to herein as Furuta polymer. A Furuta polymer has the following general structural formula:

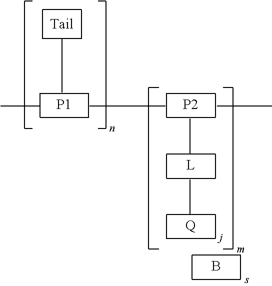

wherein a backbone structure of the co-polymer comprises repeat units of first type P1-Tail and repeat units of second type P2-L-Q, which randomly repeat. P1 and P2 are structural units independently selected from the list comprising acrylic acid, methacrylate, —repeat units for polypropylene (PP) (—[CH₂—CH(CH₃)]—), repeat units for polyethylene (PE) (—[CH₂]—), siloxane, and repeat units for polyethylene terephthalate (sometimes written poly(ethylene terephthalate)) for which the repeat unit may be expressed as —CH₂—CH₂—O—CO—C₆H₄—CO—O— and n is a number of the repeat units P1-Tail in the backbone structure which may range from 3 to 100 000 and m is number of the repeat units P2-L-Q in the backbone structure which may range from 3 to 100 000. The ratio n:m may range from 10:1 and 1:10. The first type of structural units (P1) has a resistive substitute Tail, which is an oligomer of polymeric material. Such an oligomer may have a HOMO-LUMO gap no less than 2 eV. The repeat units P2-L-Q have an ionic functional group Q connected to said structural unit P2 via a linker group L.

The ionic functional group Q is comprised of ionic liquid ions from the class of ionic compounds that are used in ionic liquids, zwitterions, or polymeric acids. The parameter j is a number of Q groups attached to the linker group L, and may range from 1 to 5. The energy interaction of the ionic liquid ions tethered via L to discrete P2 structural units may be less than kT, where k is Boltzmann constant and T is the temperature of environment. B's are counter ions, which are molecules, oligomers, or a Furuta polymer that can supply an opposite charge to balance a charge of the co-polymer; s is number of the counter ions. The ratio s:(mj) may range from 1:1 to 1:5, and in its preferred embodiment is 1:1.

In another aspect, the present disclosure provides a meta-dielectric material comprising one or more types of Furuta polymers. The Furuta polymers comprising the organic co-polymeric compound according as disclosed above with resistive envelope built with resistive substitute Tail and polarizable ionic liquids/zwitterions/polymeric acids (Q) tethered to a co-polymer backbone where the ionic groups Q have electronic or ionic type of polarizability provided by electronic conductivity or limited ion mobility of ionic functional groups Q.

In another aspect, the present disclosure provides a meta-capacitor comprising two metal electrodes and a molecular dielectric film between the two electrodes comprising the organic co-polymeric compound as disclosed above with a resistive envelope built with resistive substitute Tails and polarizable ionic liquids/zwitterions/polymeric acids tethered to a co-polymer backbone where the ionic liquid has electronic or ionic type of polarizability provided by electronic conductivity or limited ion mobility of ionic functional groups Q.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWING

FIG. 1A schematically shows the disclosed capacitor with flat and planar electrodes.

FIG. 1B schematically shows the disclosed capacitor with rolled (circular) electrodes.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure provides an organic co-polymeric compound having the structure described above. In one embodiment of the organic co-polymeric compound, the resistive substitute Tails are independently selected from the list comprising oligomers of polypropylene (PP), oligomers of polyethylene terephthalate (PET), oligomers of polyphenylene sulfide (PPS), oligomers of polyethylene naphthalate (PEN), oligomers of polycarbonate (PP), polystyrene (PS), and oligomers of polytetrafluoroethylene (PTFE). In another embodiment of the organic co-polymeric compound, the resistive substitutes Tail are independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, iso-butyl and tert-butyl groups, and the aryl group is selected from phenyl, benzyl and naphthyl groups. The resistive substitute Tail may be added after polymerization.

In yet another aspect of the present disclosure, it is preferable that the HOMO-LUMO gap is no less than 4 eV. In still another aspect of the present disclosure, it is even more preferable that the HOMO-LUMO gap is no less than 5 eV. The ionic functional group Q comprises one or more ionic liquid ions from the class of ionic compounds that are used in ionic liquids, zwitterions, or polymeric acids. The energy of interaction between Q group ions on discrete P₂ structural units may be less than kT, where k is Boltzmann constant and T is the temperature of environment. The temperature of environment may be in range between—60 C of and 150 C. The preferable range of temperatures is between—40 C and 100 C. Energy interaction of the ions depends on the effective radius of ions. Therefore, by increasing the steric hindrance between ions it is possible to reduce energy of interaction of ions. In one embodiment of the present invention, at least one ionic liquid ion is selected from the list comprising [NR₄]⁺, [PR₄]⁺ as cation and [—CO₂]⁻, [—SO₃]⁻, [—SR₅]⁻, [—PO₃R⁻]⁻, [—PR₅]⁻ as anion, wherein R is selected from the list comprising H, alkyl, and fluorine. The functional group Q may be charged after or before polymerization. In another embodiment of the present invention, the linker group L is oligomer selected from structures 1 to 6 as given in Table 1.

TABLE 1
Examples of the oligomer linker group

| | |
|---|---|
| 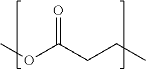 | 1 |
| 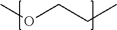 | 2 |
| 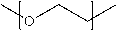 | 3 |
| 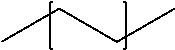 | 4 |
| 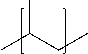 | 5 |
| 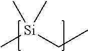 | 6 |

In yet another embodiment of the present invention, the linker group L is selected from structures 7 to 16 as given in Table 2.

TABLE 2
Examples of the linker group

| | |
|---|---|
| —O— | 1 |
| 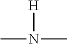 | 2 |
| 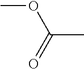 | 3 |
| 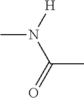 | 4 |
| 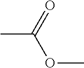 | 5 |
| 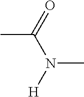 | 6 |
| 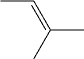 | 7 |
| 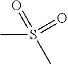 | 8 |
| 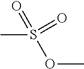 | 9 |
| 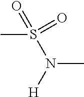 | 10 |

In yet another embodiment of the present invention, the linker group L may be selected from the list comprising CH₂, CF₂, SiR₂O, and CH2CH2O, wherein R is selected from the list comprising H, alkyl, and fluorine. The ionic functional group Q and the linker groups L may be added after polymerization.

In another aspect, the present disclosure provides a dielectric material (sometimes called a meta-dielectric) comprising of one or more of the class of Furuta polymers comprising protected or hindered ions of zwitterion, cation, anion, or polymeric acid types described hereinabove. The meta-dielectric material may be a mixture of zwitterion type Furuta polymers, or positively charged (cation) Furuta polymers and negatively charged (anion) Furuta polymers, polymeric acid Furuta polymers, or any combination thereof. The mixture of Furuta polymers may form or be induced to form supra-structures via hydrophobic and ionic interactions. By way of example, but not limiting in scope, the cation on a positively charged Furuta polymer replaces the B counter ions of the anion on a negatively charged Furuta polymer parallel to the positively charged Furuta polymer and vice versa; and the resistive Tails of neighboring Furuta polymers further encourages stacking via van der Waals forces, which increases ionic group isolation. Meta-dielectrics comprising both cationic and anionic Furuta polymers have a 1:1 ratio of cationic and anionic Furuta polymers.

The Tails of hydrocarbon (saturated and/or unsaturated), fluorocarbon, siloxane, and/or polyethylene glycol linear or branched act to insulate linked/tethered/partially immobilized polarizable ionic liquids, zwitterions, or polymeric acids (ionic Q groups). The Tails insulate the ionic Q groups from other ionic Q groups on the same or parallel Furuta polymer via steric hindrance of the ionic Q groups' energy of interaction, which favorably allows discrete polarization of the ionic Q groups (i.e. polarization of cationic liquid and anionic liquid tethered/partially immobilized to parallel Furuta polymers). Further, the Tails insulate the ionic groups of supra-structures from each other. Parallel Furuta polymers may arrange or be arranged such that counter ionic liquids (i.e. tethered/partially immobilized ionic liquids (Qs) of cation and anion types) are aligned opposite from one another (sometimes known as cationic Furuta polymers and anionic Furuta polymers).

The Furuta polymers have hyperelectronic or ionic type polarizability. “Hyperelectronic polarization may be considered due to the pliant interaction of charge pairs of excitons, localized temporarily on long, highly polarizable molecules, with an external electric field [.] (Roger D. Hartman and Herbert A. Pohl, “Hyper-electronic Polarization in Macromolecular Solids”, Journal of Polymer Science: Part A-1 Vol. 6, pp. 1135-1152 (1968)).” Ionic type polarization can be achieved by limited mobility of ionic parts of the tethered/partially immobilized ionic liquid or zwitterion (Q). Additionally, other mechanisms of polarization such as dipole polarization and monomers and polymers possessing metal conductivity may be used independently or in combination with hyper-electronic and ionic polarization in aspects of the present disclosure.

Further, a meta-dielectric layer may be comprised of one or more types of zwitterion Furuta polymer and/or selected from the anionic Q⁺ group types and cationic Q⁻ group types and/or polymeric acids, having the general configuration of Furuta polymers:

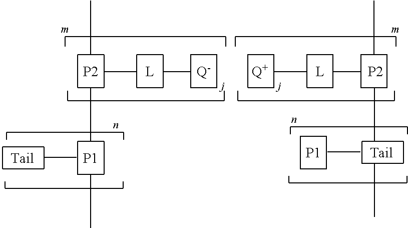

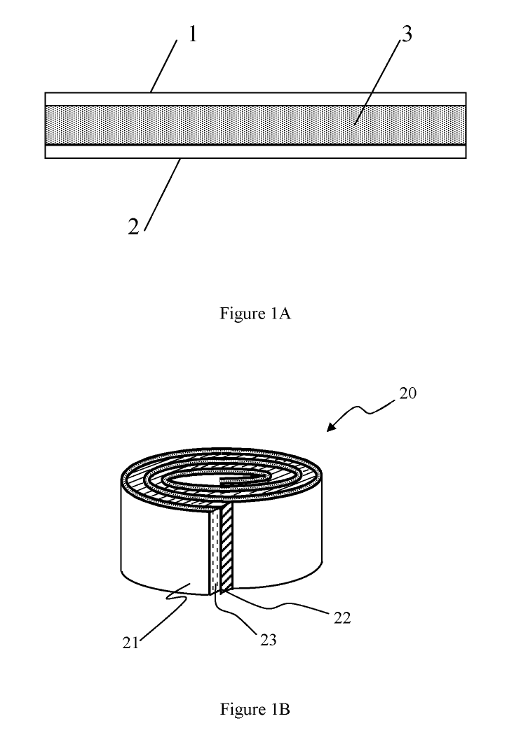

In yet another aspect, the present disclosure provides a meta-capacitor shown in FIG. 1A. The meta-capacitor comprises a first electrode 1, a second electrode 2, and a meta-dielectric layer 3 disposed between said first and second electrodes. The electrodes 1 and 2 may be made of a metal, such as copper, zinc, or aluminum or other conductive material and are generally planar in shape.

The electrodes 1, 2 may be flat and planar and positioned parallel to each other. Alternatively, the electrodes may be planar and parallel, but not necessarily flat, e.g., they may coiled, rolled, bent, folded, or otherwise shaped to reduce the overall form factor of the capacitor. It is also possible for the electrodes to be non-flat, non-planar, or non-parallel or some combination of two or more of these.

By way of example and not by way of limitation, a spacing d between the electrodes 1, 2 which may correspond to the thickness of the Composite Dielectric Film layer 3 may range from about 100 nm to about 10 000 μm. As noted in Equation (2) below, the maximum voltage V_{bd} between the electrodes 1, 2 is approximately the product of the breakdown field E_{bd} and the electrode spacing d.

V_{bd}=E_{bd}d (2)

For example, if, E_{bd}=0.1 V/nm and the spacing d between the electrodes 1, 2 is 10,000 microns (100,000 nm), the maximum voltage V_{bd} would be 100,000 volts.

The electrodes 1, 2 may have the same shape as each other, the same dimensions, and the same area A. By way of example, and not by way of limitation, the area A of each electrode 1, 2 may range from about 0.01 m² to about 1000 m². By way of example and not by way of limitation, for rolled capacitors, the electrodes may be up to, e.g., 1000 m long and 1 m wide.

These ranges are non-limiting. Other ranges of the electrode spacing d and area A are within the scope of the aspects of the present disclosure.

If the spacing d is small compared to the characteristic linear dimensions of electrodes (e.g., length and/or width), the capacitance C of the capacitor may be approximated by the formula:

C=κ∈₀A/d, (3)

where ∈₀ is the permittivity of free space (8.85×10⁻¹² Coulombs²/(Newton·meter²)) and κ is the dielectric constant of the dielectric layer. The energy storage capacity U of the capacitor may be approximated as:

U=½CV_{bd}² (4)

which may be rewritten using equations (2) and (3) as:

U=½κ∈₀AE_{bd}² (5)

The energy storage capacity U is determined by the dielectric constant κ, the area A, and the breakdown field E_{bd}. By appropriate engineering, a capacitor or capacitor bank may be designed to have any desired energy storage capacity U. By way of example, and not by way of limitation, given the above ranges for the dielectric constant κ, electrode area A, and breakdown field E_{bd} a capacitor in accordance with aspects of the present disclosure may have an energy storage capacity U ranging from about 500 Joules to about 2×10¹⁶ Joules.

For a dielectric constant κ ranging, e.g., from about 100 to about 1,000,000 and constant breakdown field E_{bd} between, e.g., about 0.1 and 0.5 V/nm, a capacitor of the type described herein may have a specific energy capacity per unit mass ranging from about 10 W·h/kg up to about 100,000 W·h/kg, though implementations are not so limited.

Aspects of the present disclosure include meta-capacitors that are coiled, e.g., as depicted in FIG. 1B. In this example, a meta-capacitor 20 comprises a first electrode 21, a second electrode 22, and a meta-dielectric material layer 23 of the type described hereinabove disposed between said first and second electrodes. The electrodes 21, 22 may be made of a metal, such as copper, zinc, or aluminum or other conductive material and are generally planar in shape. In one implementation, the electrodes and meta-dielectric material layer 23 are in the form of long strips of material that are sandwiched together and wound into a coil along with an insulating material, e.g., a plastic film such as polypropylene or polyester to prevent electrical shorting between the electrodes 21, 22. Examples of such coiled capacitor energy storage devices are described in detail in commonly-assigned U.S. patent application Ser. No. 14/752,600, filed Jun. 26, 2015, the entire contents of which are incorporated herein by reference.

In order that the invention may be more readily understood, reference is made to the following examples, which are intended to be illustrative of the invention, but are not intended to be limiting the scope.

### Example 1

Carboxylic acid co-polymer P002. To a solution of 1.02 g (11.81 mmol) of methacrylic acid and 4.00 g (11.81 mmol) of stearylmethacrylate in 2.0 g isopropanol was added a solution of 0.030 g 2,2′-azobis(2-methylpropionitrile) (AIBN) in 5.0 g of toluene. The resulting solution was heated to 80 C for 20 hours in a sealed vial, after which it became noticeably viscous. NMR shows <2% remaining monomer. The solution was used without further purification in film formulations and other mixtures.

### Example 2

Amine co-polymer P011. To a solution of 2.52 g (11.79 mmol) of 2-(diisopropylamino)ethyl methacrylate and 3.00 g (11.79 mmol) of laurylmethacrylate in 2.0 g toluene was added a solution of 0.030 g 2,2′-azobis(2-methylpropionitrile) (AIBN) in 4.0 g of toluene. The resulting solution was heated to 80 C for 20 hours in a sealed vial, after which it became noticeably viscous. NMR shows <2% remaining monomer. The solution was used without further purification in film formulations and other mixtures.

### Example 3

Carboxylic acid co-polymer and amine co-polymer mixture. 1.50 g of a 42 wt % by solids solution of P002 was added to 1.24 g of a 56 wt % solution of P011 with 1 g of isopropanol and mixed at 40 C for 30 minutes. The solution was used without further purification.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. As used herein, in a listing of elements in the alternative, the word “or” is used in the logical inclusive sense, e.g., “X or Y” covers X alone, Y alone, or both X and Y together, except where expressly stated otherwise. Two or more elements listed as alternatives may be combined together. The appended claims are not to be interpreted as including means-plus-function limitations, unless such a limitation is explicitly recited in a given claim using the phrase “means for.”

What is claimed is:

1. An organic co-polymeric compound characterized by polarizability and resistivity that is having a following general structural formula: 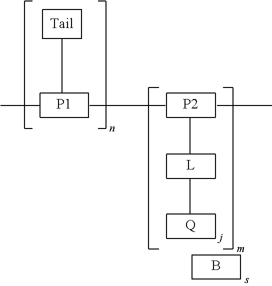
wherein a backbone structure of the organic co-polymeric compound comprises repeat units of a first type P1-Tail and repeat units of a second type P2-L-Q, both of which randomly repeat, wherein P1 and P2 are structural units independently selected from the list comprising acrylate, methacrylate, repeat units for polypropylene (PP), repeat units for polyethylene (PE), siloxane, and repeat units for polyethylene terephthalate, n is a number of the P1-Tail repeat units in the backbone structure ranging from 3 to 100 000 and m is a number of the P2-L-Q repeat units in the backbone structure ranging from 3 to 100 000,
wherein Tail is a resistive substitute that includes an oligomer of a polymeric material
wherein Q is an ionic functional group which is connected to the structural unit P2 via a linker group L, wherein j is a number of ionic functional groups Q attached to the linker group L ranging from 1 to 5,
wherein the ionic functional group Q comprises one or more ionic liquid ions, zwitterions, or polymeric acids;
wherein B is a counter ion in the form of a molecule or oligomer that can supply an opposite charge to balance a charge of the co-polymer, and wherein s is the number of the counter ions in the organic co-polymeric compound.

2. The organic co-polymeric compound of claim 1, wherein the resistive substitute Tail is independently selected from the list comprising oligomers of polypropylene (PP), oligomers of polyethylene terephthalate (PET), oligomers of polyphenylene sulfide (PPS), oligomers of polyethylene naphthalate (PEN), oligomers of polycarbonate (PP), oligomers of polystyrene (PS), and oligomers of polytetrafluoroethylene (PTFE).

3. The organic co-polymeric compound of claim 1, wherein the resistive substitute Tails are independently selected from alkyl, aryl, substituted alkyl, substituted aryl, fluorinated alkyl, chlorinated alkyl, branched and complex alkyl, branched and complex fluorinated alkyl, branched and complex chlorinated alkyl groups, and any combination thereof, and wherein the alkyl group is selected from methyl, ethyl, propyl, butyl, I-butyl and t-butyl groups, and the aryl group is selected from phenyl, benzyl and naphthyl groups.

4. The organic co-polymeric compound of claim 1, wherein Tail is a resistive substitute that includes an oligomer of a polymeric material with a HOMO-LUMO gap no less than 2 eV

5. The organic co-polymeric compound of claim 4, wherein the HOMO-LUMO gap is no less than 4 eV.

6. The organic co-polymeric compound of claim 4, wherein the HOMO-LUMO gap is no less than 5 eV.

7. The organic co-polymeric compound of claim 1, wherein at least one ionic liquid ion is selected from the list comprising [NR₄]⁺, [PR₄]⁺ as cation and [—CO₂]⁻, [—SO₃]⁻, [—SR₅]⁻, [—PO₃R]⁻, [—PR₅]⁻ as anion, wherein R is selected from the list comprising H, alkyl, and fluorine.

8. The organic co-polymeric compound of claim 1, wherein the linker group L is an oligomer selected from structures 1 to 6:

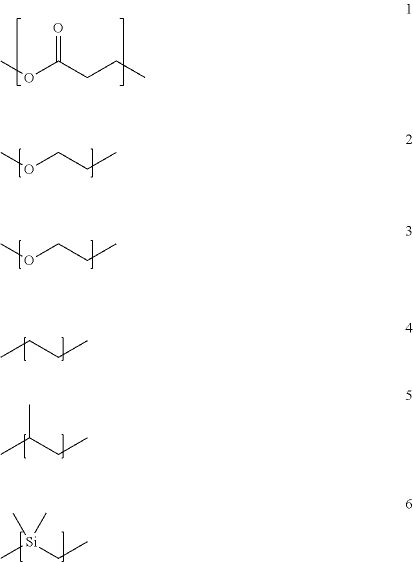

9. The organic co-polymeric compound of claim 1, wherein the linker group L is selected from structures 7 to 10:

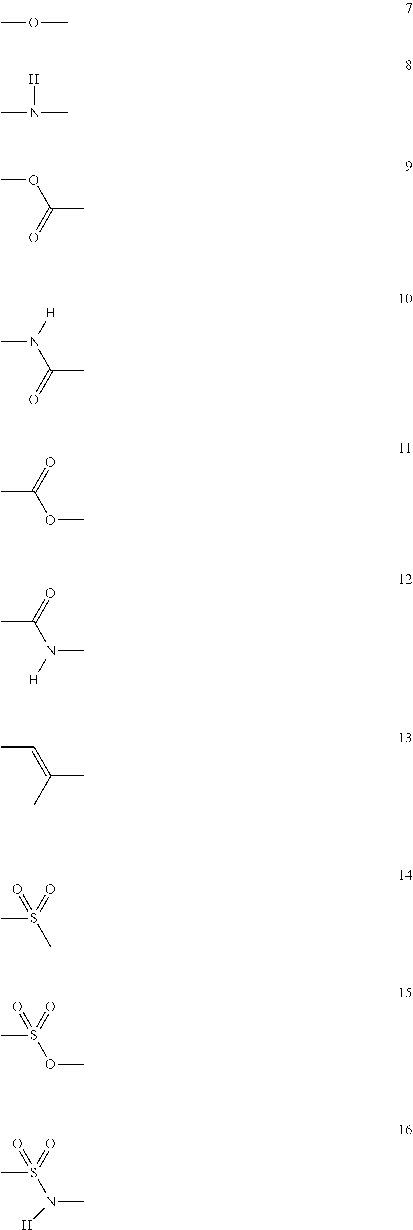

10. The organic co-polymeric compound of claim 1, wherein the linker group L is selected from the list comprising CH₂, CF₂, SiR₂O, CH₂CH₂O, wherein R is selected from the list comprising H, alkyl, and fluorine.

11. The organic co-polymeric compound of claim 1, wherein an energy interaction of the ionic liquid ions is less than kT, where k is Boltzmann's constant and T is a temperature of an environment.

12. The co-polymeric compounds of any of claims 1 to 11, wherein the co-polymeric compounds, can form ordered or semi-ordered structures via hydrophobic-hydrophilic interactions and/or ionic interactions.

13. A meta-dielectric layer comprising a mixture of co-polymeric compounds according to any of claims 1 to 12.

14. The meta-dielectric layer of claim 13, wherein the mixture of co-polymeric compounds is electrically neutral.

15. The meta-dielectric layer of claim 14, wherein the mixture of co-polymeric compounds has the following general structural configuration: 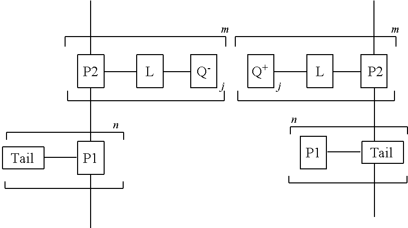
where Q⁺ is an cationic functional group comprised of ionic liquid anions and Q⁻ is a anionic functional group comprised of ionic liquid cations.

16. The meta-dielectric layer of claim 13, wherein the co-polymeric compounds are selected for counter balancing the charges of the tethered/partially immobilized ionic liquids of each other.

17. The meta-dielectric film of claim 13, wherein the film's relative permittivity is greater than or equal to 1000.

18. The meta-dielectric film of claim 13, wherein the film's resistivity is greater than or equal to 10¹³ ohm/cm

19. A Composite Dielectric Capacitor comprising two metal electrodes and Composite Dielectric film between the two electrodes, the Composite Dielectric film comprising an organic co-polymeric compound having a resistive envelope built with a resistive substitute Tail and a polarizable ionic liquid or partially immobilized ion or polymeric acid tethered to a co-polymer backbone, wherein the ionic liquid has an electronic or ionic type of polarizability provided by electronic conductivity or limited ion mobility of one or more ionic functional groups.
